(19) United States
(12) Patent Application Publication
(10) Pub. No.: US 2016/0134750 A1
(43) Pub. Date: May 12, 2016

(54) INCOMING CALL IDENTIFICATION

(71) Applicant: NOKIA TECHNOLOGIES OY, Espoo (FI)

(72) Inventors: Hongrui Shen, Beijing (CN); Naichen Cui, Beijing (CN); Jing Wu, Beijing (CN); Yaochu Que, Beijing (CN)

(21) Appl. No.: 14/898,215

(22) PCT Filed: Jun. 20, 2013
(86) PCT No.: PCT/CN2013/077598

§ 371 Date: Dec. 14, 2015

(51) Int. Cl. H04M 3/42; H04W 4/14; H04L 29/08

(52) U.S. Cl. CPC H04M 3/42068; H04L 67/22; H04M 3/42221; H04W 4/14; H04M 3/42017

(57) ABSTRACT

In one embodiment, at least a portion of a telephone call from an unknown caller is recorded and played in response to a subsequent call from the unknown caller. At a telephone or a network device, a caller identification number associated with an incoming call is received. A query for a contact database using the caller identification number is generated, and if an empty result is returned from the contact database, a recording for the caller identification number is accessed. The user is presented with an option to play the recording for the caller identification number such that the user initiates a command to play the recording for the caller identification number.

### FIELD

The following disclosure relates to the identification of unknown incoming calls.

### BACKGROUND

Caller identification notification is available in the plain old telephone service (POTS) systems, cellular telephone systems, and voice over internet protocol (VoIP) systems to identify a name or number of a calling party to a called party. The name or the number of the calling party may be sent during the ringing phase of the call, or in some VoIP systems, in the setup phase of the communication session.

Various techniques are available for associating the name of the calling party with the number of the calling party. In some techniques, a switching point associated with the calling party accesses and sends the information with the call, or a switching point associated with the called party accesses a database to match the number of the calling party with the name of the calling party.

Newer techniques in cellular phones and internet protocol (IP) phones may internally match the number of the calling party to the name of the calling party. However, the list of contacts must be maintained by the user. Users may forget to save some phone numbers. In addition, some users may desire to omit certain calling party names from the list of contacts to maintain a level of anonymity in case the IP phone or cellular phone is lost or stolen.

### SUMMARY

In one embodiment, at least a portion of a telephone call from an unknown caller is recorded and played in response to a subsequent call from the unknown caller. At a telephone or a network device, a caller identification number associated with an incoming call is received. A query for a contact database using the caller identification number is generated, and if an empty result is returned from the contact database, a recording for the caller identification number is accessed. The user is presented with an option to play the recording for the caller identification number such that the user initiates a command to play the recording for the caller identification number.

### BRIEF DESCRIPTION OF THE DRAWINGS

Exemplary embodiments of the present invention are described herein with reference to the following drawings.

FIG. 1 illustrates an example telephone for incoming call identification.

FIG. 2 illustrates an example flowchart for incoming call identification.

FIG. 3 illustrates an example user interface of the telephone of FIG. 1.

FIG. 4 illustrates an example memory of the telephone of FIG. 1.

FIG. 5 illustrates an example lookup table the telephone of FIG. 1.

FIG. 6 illustrates an example system for incoming call identification.

FIG. 7 illustrates another example flowchart for incoming call identification.

FIG. 8 illustrates an example server of the system of FIG. 5.

### DETAILED DESCRIPTION

When a call from an unknown caller is received, a portion of the call is recorded. The recorded portion of the call is saved. When another call is received from the unknown caller, the recorded portion of the earlier call is played back in order to remind the user of the previous conversation and/or the identity of the unknown caller. The playback of the previous conversation may be offered to the user through a prompt while the telephone is ringing, or playback of the previous conversation may be made in lieu of the telephone ringing.

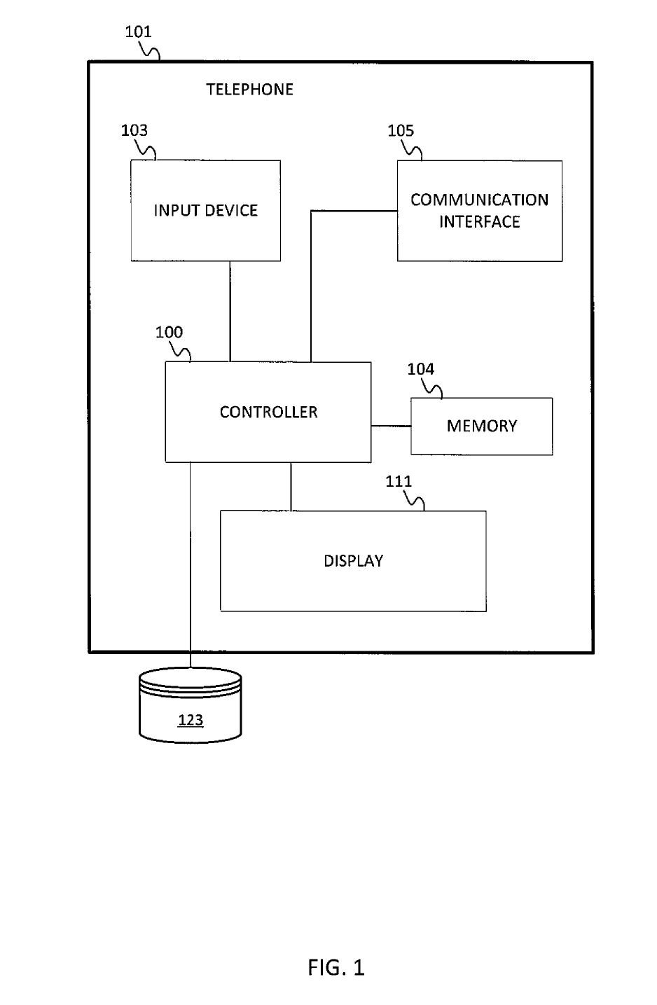

FIG. 1 illustrates an example telephone 101 for incoming call identification. The telephone 101 may be any type of mobile computing device. The term telephone includes cellular telephones, voice over internet protocol (VoIP) telephones, analog telephones, video telephones, digital telephones, plain old telephone system (POTS) telephones, voice grade telephones, smart phones, and virtual telephones. A virtual telephone or a VoIP telephone may include software and/or hardware components running on a personal computer, a laptop computer, a tablet computer, a personal digital assistant (“PDA”), or the computing device side of a smart phone. The computing device side of a smart phone refers to a mobile application or other type of software that performs telephone functions but utilizes only the data network portion of the smart phone. In other words, the computing device side of the smart phone relies on data channels on the cellular network or other wireless network and does not utilize voice channels on the cellular network.

The telephone 101 includes a controller 100, an input device 103, a communication interface 105, a memory 104, and a display 111. The telephone 101 may be coupled with an external database 123. The telephone 101 may be configured for various forms of communication. An example includes voice grade telephone communication, which may be limited to a voice band path (e.g., a frequency range from 300 Hz to 3400 Hz). Another example includes cellular networks, such as the analog advanced mobile phone system (AMPS), the global system for mobile communication (GSM), third generation partnership project (3GPP), code division multiple access (CDMA), personal handy-phone system (PHS), and 4G or long term evolution (LTE) standards.

Through one of these communication standards, a remote telephone initiates a call or a communication session with the telephone 101. The communication interface 105 receives a caller identification number associated with the call or the communication session. In analog systems, the caller identification number may be encoded using an analog data stream between the first and second rings of the call. The analog data stream may be audible signals transmitted in the voice band that are converted by the telephone 101 to the data describing the caller identification number (e.g., audio frequency shift keying, differential phase shift keying, or Bell 202 modulation). Also in analog systems, the caller identification number may be encoded on dual tone multi-frequency (DTMF) keying over the voice band.

In digital systems, the caller identification number may be encoded into the voice band as described above. Alternatively, a calling number identification (CNID) may be encoded into a data packet or a digital stream of data. For example, the telephone 101 may be configured to capture the automated number identification (ANI) data

The caller identification number may be encoded in a setup message. The caller identification number may be a binary coded decimal (BCD) in a type length value element. The setup message may include other content such as the called party number, the capabilities of the calling device, the capabilities of the called device, and other information. In one example the caller identification number, which may be referred to as a calling party BCD number, is encoded using the information element shown in Table 1. The type of number may designate national, international, unknown, proprietary network, or another value. The numbering plan identification may identify prefix, suffixes, area codes, and/or other number schemes that define the calling party number. The presentation indicator includes a value set by the calling part to determine whether or not the calling party number is presented to the called party. The presentation indicator may be restricted or allowed. The screening indicator may include the results of a screening process of the called party. Example values for the screening indicator include network provided, user provided and not screened, user provided and passed, and user provided and failed.

TABLE 1

| | | | | | | | |
|---|---|---|---|---|---|---|---|
| Bit: 8 | 7 | 6 | 5 | 4 | 3 | 2 | 1 |

| | Calling party BCD number IEI | | | | | octet 1 |
|---|---|---|---|---|---|---|
| Length of calling party BCD number contents | | | | | | octet 2 |
| 0/1 | type of | | Numbering plan | | | octet 3 |
| ext | number | | identification | | | |
| 1 | presentation | 0 | 0 | 0 | screening | octet 3a |
| ext | indicator | | spare | | indicator | |

| | | |
|---|---|---|
| Number digit 2 | Number digit 1 | octet 4 |
| Number digit 4 | Number digit 3 | octet 5 |
| | | . |
| | | . |
| | | . |

In VoIP systems the caller identification number may be encoded in a data packet as according to a protocol such as H.323, session initiation protocol (SIP), or media gateway control protocol (MGCP). The calling name may be displayed in a setup or notify message of the communication session. H.323 may be defined according to the international telecommunication union recommendation H.232 “Packet-based multimedia communication systems,” as published in December 2009 and available at http://www.itu.int/rec/T-REC-H.323/. SIP may be defined according to requests for comments (RFC) 3261 as published in June 2002 and available at http://tools.ietf.org/html/rfc3261. MGCP may be defined according to RFC 2805 as published in April 2000 and available at http://tools.ietf.org/html/rfc2805.

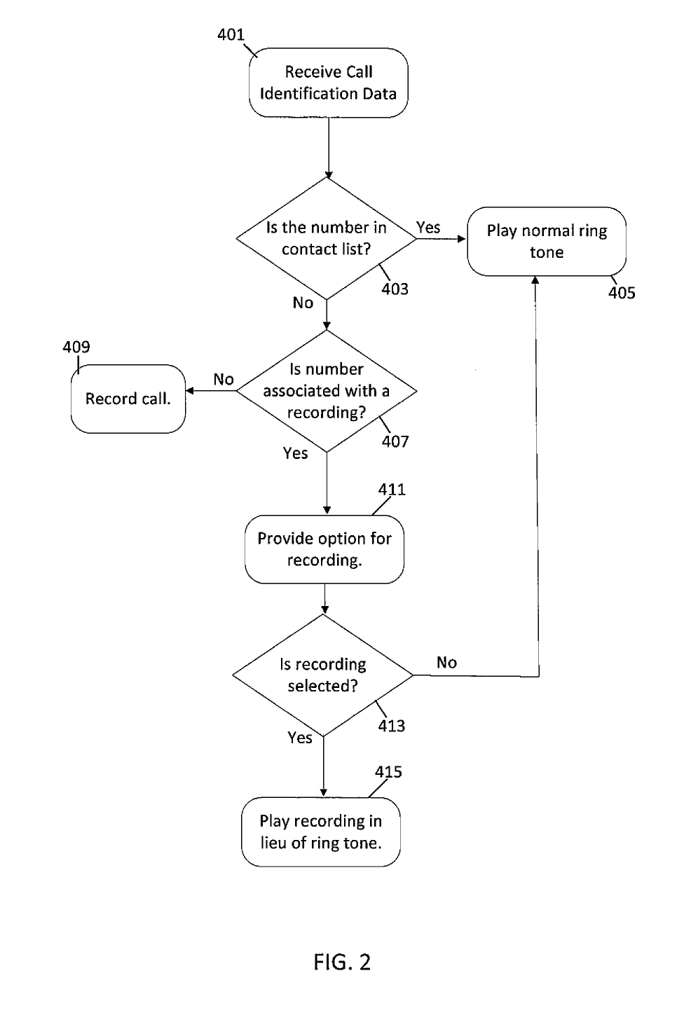

FIG. 2 illustrates an example flowchart for incoming call identification. The acts of the flowchart may be performed by various components of the telephone 101. Additional, different, or fewer acts may be provided.

At act 401, the communication interface 105 of the telephone 101 receives the call identification data that includes the caller identification number, as described above. The controller 100 is configured to query a contact database using the caller identification number. The contact database may be stored locally on the telephone 101 or on another device. In one example, the contact database includes a collection of contact names and telephone numbers defined by the user. In another example, the contact database is a list of contact names and telephone numbers stored by a third party. The third party contact database may include a public phonebook in electronic format.

At act 403, the controller 100 determines whether the caller identification number is on the contact list. If the caller identification number is included in the contact list, the telephone 101 plays a normal ring tone, a specialized ring tone for the contact, or vibrates, which is shown by act 405. The type of notification may be specified by the user in the configuration of the telephone 101.

If the caller identification number is not included in the contact list, which may be referred to as an empty result, then the caller identification number is an unknown number. The controller 100 determines whether the unknown number has previously called the telephone 101. For example, the controller 100 may access a usage history of the telephone 101. The usage history may include past calls, short message service (SMS) messages, multimedia messaging service (MMS) messages, or any combination thereof. The usage history may be complete for all usage of the phone, the usage since the last power cycle, the usage since the user cleared the usage history, the usage since the telephone 101 was activated, or the usage over a predetermined time frame. Example predetermined time frames include a week, a month, and a year.

In addition to or as part of checking whether the unknown number has previously called the telephone 101, the controller 100 may check whether the unknown number is associated with a recording, as shown by act 407. In one embodiment, if the unknown number is not associated with a recording, the controller 101 records a predetermined portion of the incoming call, as shown by act 409. The recording may be stored in memory 104 or in an external database (e.g., database 123).

In one example, the first time the unknown caller places a call to the telephone 101, the recording is stored in memory 104 and subsequent recording are not made. In another example, each time the unknown caller places a call to the telephone 101, the recording is replaced or appended. The recording may be replaced with a new recording for each subsequent call since the initial call from the unknown caller. The recording may be appended such that a recording from a second or subsequent call is appended to the recording from the initial call. The recording may include audio and/or video data.

If the unknown number is already associated with a recording, the controller 101 is configured to present an option to the user for playing the recording, as shown by act 411. The option may be a prompt displayed such as “Play recording for this number?” or “Play caller identity reminder.”

The controller 101 receives the user command and determines whether the recording has been selected at act 413. If the recording is not selected, the telephone 101 plays the normal ring tone, a specialized ring tone for the contact, or vibrates as set by the user in the configuration of the telephone 101, as shown by act 405. If the recording is selected, the telephone plays the recording, which may be in lieu of a ring tone. In one example, the telephone 101 answers the incoming call, places the call on hold, and plays the recording to the user of the telephone 101. Alternatively, the recording may be played automatically without prompting and/or receiving input from the user (e.g., acts 411 and 413 may be omitted in an automatic playback mode).

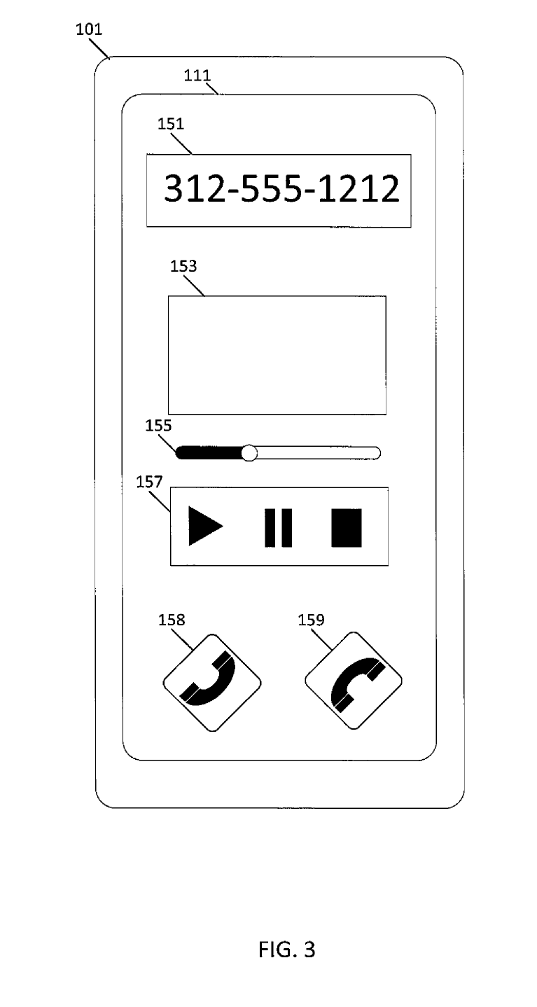

FIG. 3 illustrates an example user interface of the display 111 of the telephone 101 of FIG. 1. The user interface includes a caller identification number 151, a messaging portion 153, a progress bar 155, a set of playback controls 157, an accept call input 158, and a decline call input 159. The accept call input 158 receives an command from the user to answer an incoming call, and the decline call input 159 receives an command from the user to decline to answer an incoming call.

The caller identification number 151 may be replaced with a contact name when the controller 101 determines that the caller identification number is included in the contact database. Alternatively, the contact name may be displayed in the messaging portion 153 at the same time as the caller identification number 151. The messaging portion 153 may also be configured to display other data generated by the controller 101. The messaging portion 153 may prompt the user when a recording is available for the incoming call. The messaging portion 153 may prompt the user when the initial call is received to determine whether a recording should be made for the initial call. The messaging portion 153 may also display portions of a usage history associated with the unknown number. The portions of the usage history may include the frequency, time and date, and duration of previous calls from the unknown number. The usage history may include the frequency, time and date, and content (e.g., actual text) of SMS messages and/or MMS message received from the unknown number.

The progress bar 155 and the set of playback controls 157 receive commands from the user for playback of the recording. The progress bar 155 illustrates the current point in time in the playback of the recording. The progress bar 155 may be moved by the user to advance or rewind the playback. The playback controls 157 may also include a play command input, a pause command input, and a stop command input to control the playback of the recording.

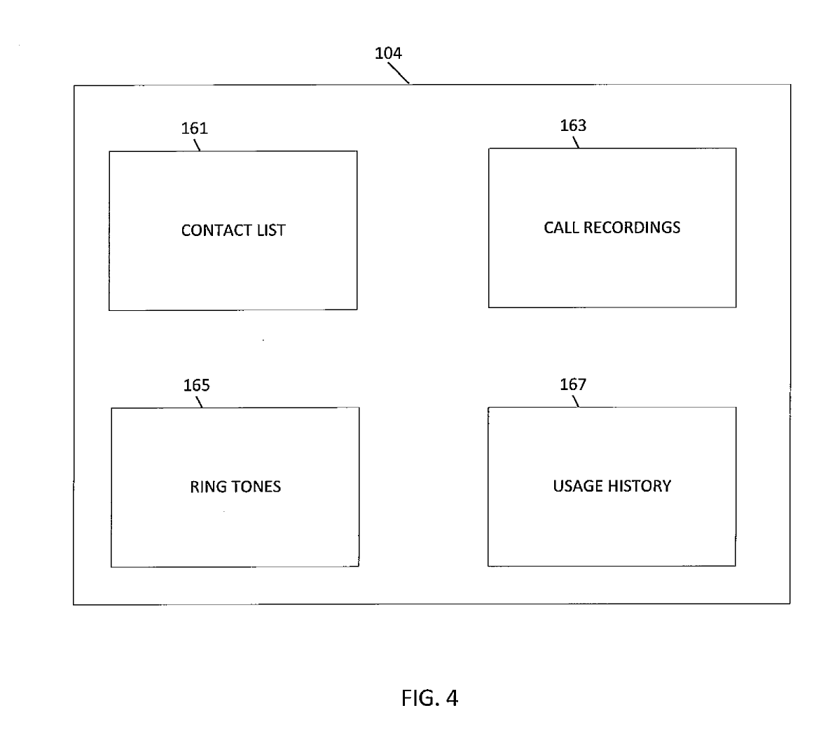

FIG. 4 illustrates an example memory 104 of the telephone 101 of FIG. 1. The memory 104 may include a contact list portion 161, call recording portion 163, ring tone portion 165, and a usage history portion 167. The contact list portion 161 may store telephone numbers, IP addresses, or another unique identifier in pairwise combination with contact names. The call recording portion 163 stores audio files or video files of the recordings of phone calls. The ring tone portion 165 includes audio files for telephone rings or type values for available ring tones in the telephone 101. The usage history portion 167 includes instances of telephone calls and text messages (SMS and/or MMS) associated with telephone numbers.

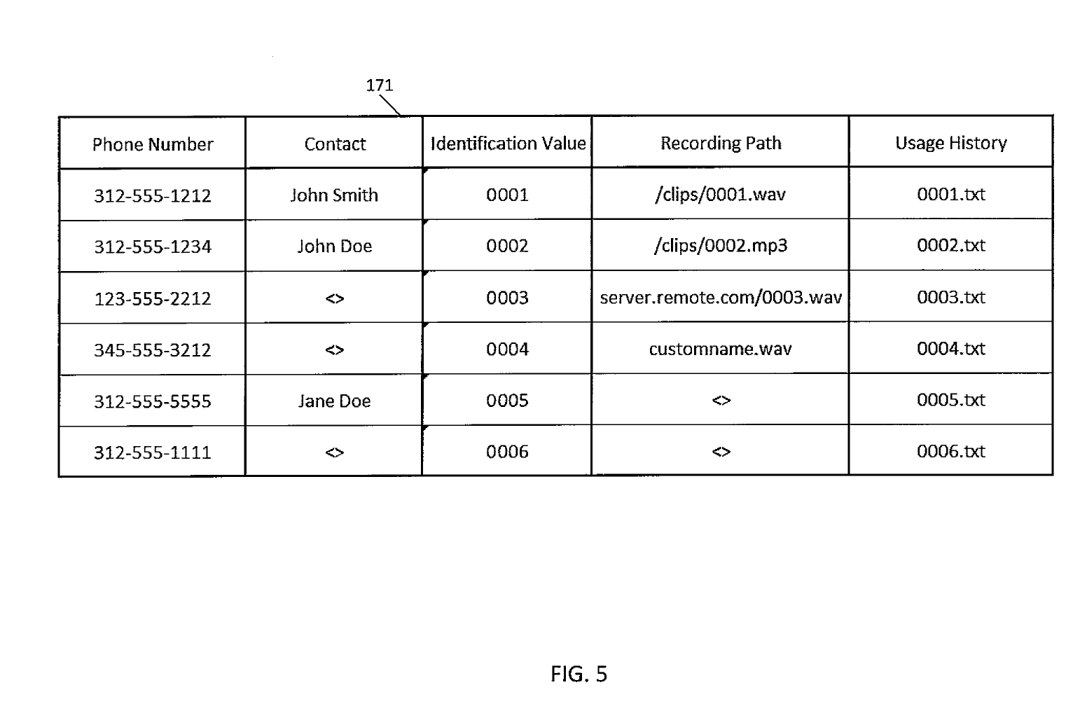

FIG. 5 illustrates an example lookup table 171 for organization of the data of the memory 104 the telephone 101. The lookup table 171 includes data organized in columns such as phone number, contact name, identification value, recording path, and usage history. The phone number may be in the format of a calling number identification. Each entry in the lookup table 171 is associated with a phone number. The identification value may be an alphanumeric value for identifying the entry. The identification value may be assigned by the telephone 101 and may have less data (e.g., three or four characters) than the 10 digit telephone numbers.

Some entries in the lookup table 171 may not include a contact name. Such entries may have a null value in the contact name field. When the controller 101 receives a null value from the lookup table 171 for the contact name, the controller 101 identifies an unknown call.

The recording path data associated with the phone number. The recording path includes a file path and a file name. The file name may be any various audio and/or video formats. Examples formats include .wav, .mp3, .mp4, .wma, 3gPP multimedia file, or other formats. Some entries in the lookup table 171 may not include a recording file. Such entries may have a null value in the recording path field. When the controller 101 queries the lookup table 171 and receives a null value from the lookup table 171 for the recording file, the controller 101 determines that no recording has been made for the phone number and makes a recording for the received call.

In one embodiment, the controller 101 may update the lookup table 171 according to a user input. For example, when the user input enters a contact name for phone number, the controller 101 determines that the phone number for the entry is no longer an unknown caller. Accordingly, the controller 101 may delete the recording associated with the phone number for the entry.

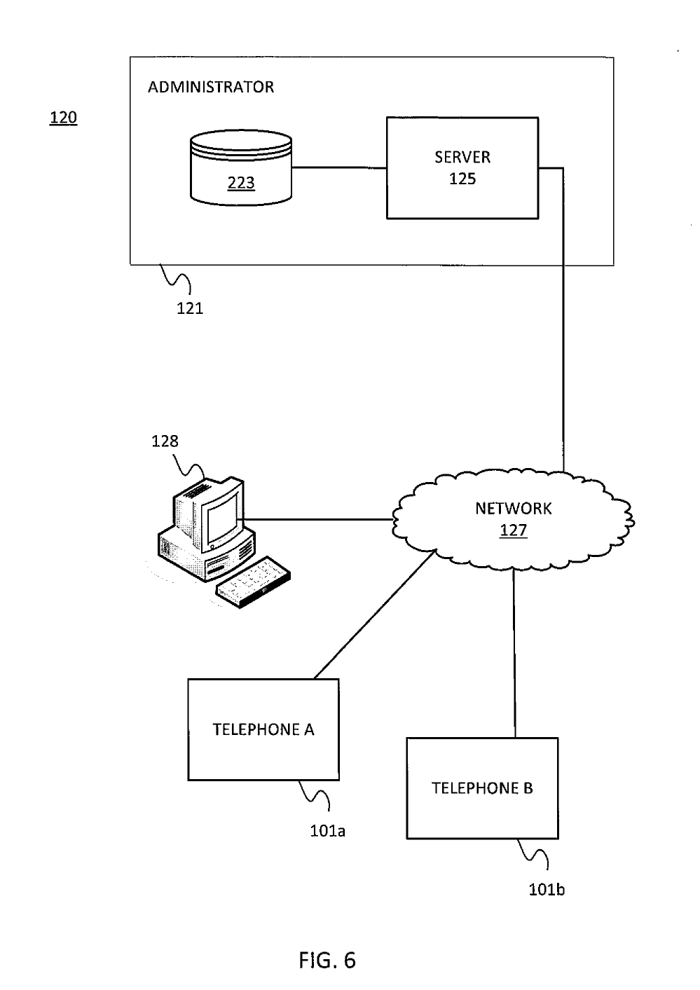

FIG. 6 illustrates an example system 120 for incoming call identification. The system 120 includes an administrator system 121, at least mobile device 101a and mobile device 101b, a workstation 128, and a network 127. Additional, different, or fewer components may be provided. The administrator system 121 includes a server 125 and a database 223. The administrator system 121 may include computer systems and networks of a telephony system operator or mobile application administrator.

Mobile device 101a may be an initiating device that initiates the call to the mobile device 101b. The call may be routed through the server 125. The server 125 and database 223 may store the lookup table 171 and the recordings. Accordingly, the server 125 may make the determination whether a contact is known and/or whether a recording exists for the incoming call before the call is forwarded to the mobile device 101b. When a contact name is present for the caller identification, the server 125 sends the contact name along with the call to the mobile device 101b. When no contact name is presented for the caller identification, the server 125 sends the recording in combination with or ahead of the call to them mobile device 125.

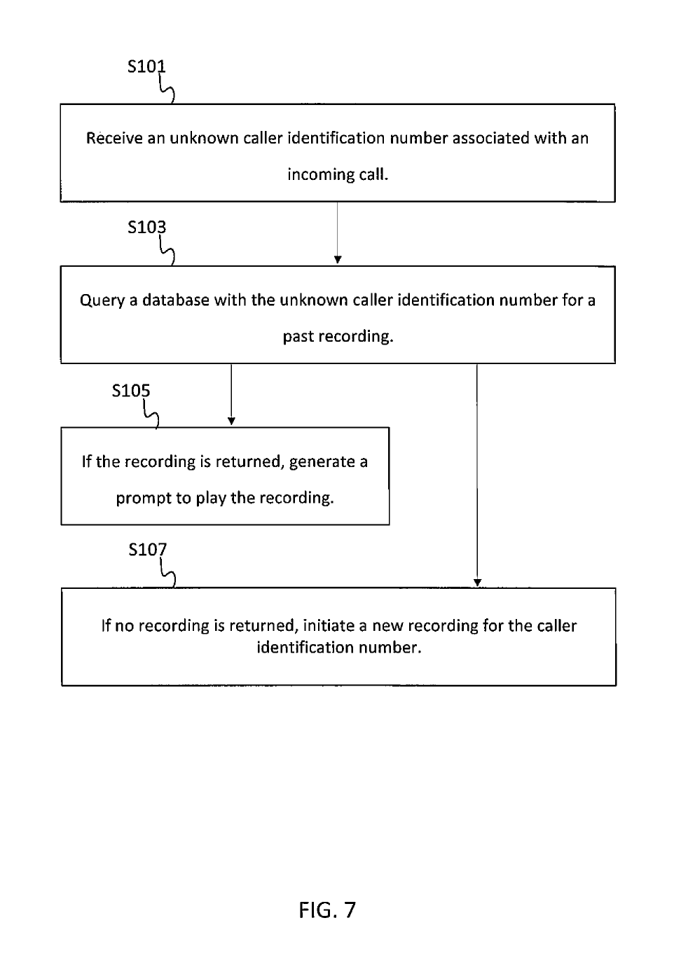

FIG. 7 illustrates another example flowchart for incoming call identification. The acts of the flowchart may be performed by the mobile device 101, the server 125, or a combination thereof. Additional, different, or fewer acts may be provided.

At act S101, an incoming call including an unknown caller identification number associated is received. The unknown caller identification number may be a phone number (e.g., 10 digits, 7 digits, or another length) or an IP address. At act S103, a database is queried with the unknown caller identification number for a past recording.

At act S105, in response to the recording returned from the database, a prompt is generated for the user to decide whether the play the recording. If the user responds affirmatively, the recording is play on the mobile device 101. The past recording may be audio or video. The past recording may be a portion of a previous call from the caller identification number. In addition to the recording, a usage history for the caller identification number may be accessed and displayed along with the prompt to play the recording.

At act S107, in response to an empty result from the database, a new recording for the caller identification number. The new recording may be the first 5 seconds of the incoming call, or another configurable amount of time. The recording may extend until the user provides a stop command. The recording may be supplemented with a voice memo added by the user. The voice memo may include the identity of the unknown called.

In one embodiment, before the new recording begins, the mobile device 101 or the server 125 checks for the legality of recording the incoming call. For example, the mobile device 101 may include position circuitry (e.g., global positioning system) that is configured to generate location data representative of the location of the mobile device. The location data is used to query a database for local laws and regulations related to recording telephone calls. If the regulations deem necessary, the mobile device 101 is configured to notify the initiated caller that the call may be recorded. The notification may be an audio message or a periodic beep or tone inserted into the audio of the call. In one embodiment, the notification is added without consideration of the geographic position of the mobile device 101 (i.e., the initiating party is notified of all recorded calls).

In addition or in the alternative, the mobile device 101 may present a confirmation message to the user of the mobile device 101 at the end of the recording or at the end of the incoming call. The confirmation message informs the user that a portion of the call is recorded and requests an instruction on whether or not to semi-permanently store the recording. The term semi-permanently means store permanently until receiving an instruction to delete. The confirmation message may state “A portion of this call was recorded. Do you want to save the recorded portion of this call with the number 312-555-1212?”

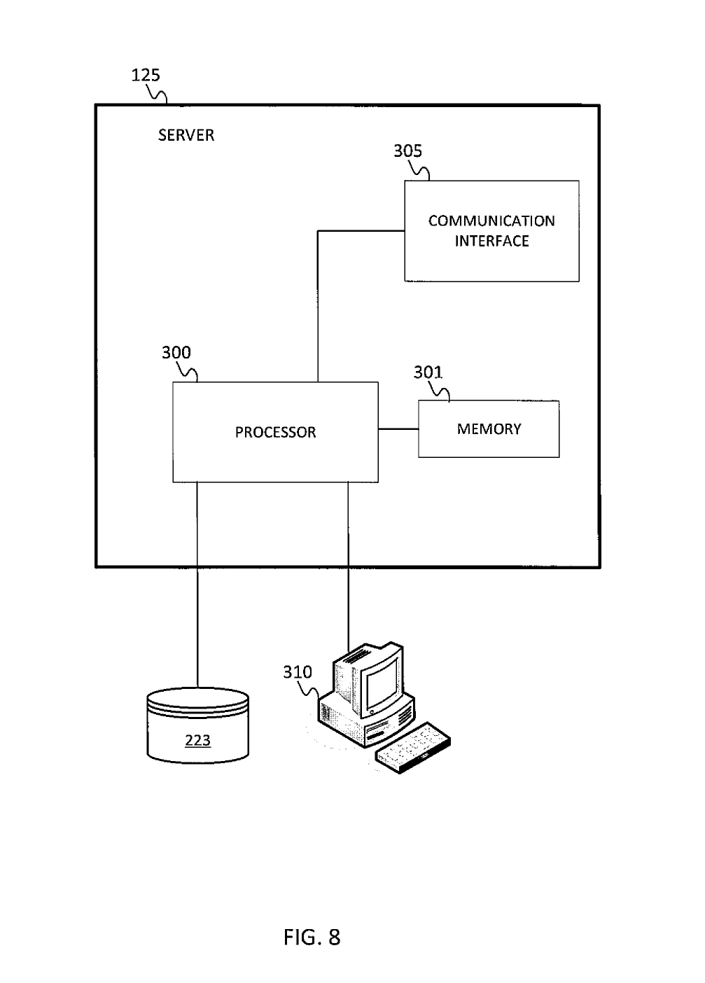

FIG. 8 illustrates an example server 125 of the system of FIG. 6. The server 125 includes a processor 300, a communication interface 305, and a memory 301. The server 125 may be coupled to a database 223 and a workstation 310. The workstation 310 may be used as an input device for the server 125. In addition, the communication interface 305 is an input device for the server 125. The communication interface 305 receives data indicative of use inputs made via the workstation 128 or the mobile device 101.

The optional workstation 128 is a general purpose computer including programming specialized for the disclosed embodiments. For example, the workstation 128 may receive user inputs for defining the duration of the recording, a setting for whether recordings are appended, and/or other thresholds. The workstation 128 includes at least a memory, a processor, and a communication interface.

The administrator system 121, the workstation 128, and the mobile devices 101 are coupled with the network 127. The phrase “coupled with” is defined to mean directly connected to or indirectly connected through one or more intermediate components. Such intermediate components may include hardware and/or software-based components.

The input device 103 may be one or more buttons, keypad, keyboard, mouse, stylist pen, trackball, rocker switch, touch pad, voice recognition circuit, or other device or component for inputting data to the mobile device 101. The input device 103 and the display 111 may be combined as a touch screen, which may be capacitive or resistive. The display 111 may be a liquid crystal display (LCD) panel, light emitting diode (LED) screen, thin film transistor screen, or another type of display.

The controller 100 and/or processor 300 may include a general processor, digital signal processor, an application specific integrated circuit (ASIC), field programmable gate array (FPGA), analog circuit, digital circuit, combinations thereof, or other now known or later developed processor. The controller 100 and/or processor 300 may be a single device or combinations of devices, such as associated with a network, distributed processing, or cloud computing.

The memory 104 and/or memory 301 may be a volatile memory or a non-volatile memory. The memory 104 and/or memory 301 may include one or more of a read only memory (ROM), random access memory (RAM), a flash memory, an electronic erasable program read only memory (EEPROM), or other type of memory. The memory 104 and/or memory 301 may be removable from the mobile device 100, such as a secure digital (SD) memory card.

The communication interface 405 and/or communication interface 305 may include any operable connection. An operable connection may be one in which signals, physical communications, and/or logical communications may be sent and/or received. An operable connection may include a physical interface, an electrical interface, and/or a data interface. The communication interface 405 and/or communication interface 305 provides for wireless and/or wired communications in any now known or later developed format.

The network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

The memory 104 and/or memory 301 may be a non-transitory computer-readable medium. While the non-transitory computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1-20. (canceled)

21. A method comprising:
receiving a caller identification number associated with an incoming call;
generating, using a processor, a query for a contact database using the caller identification number;
accessing, using the processor, a recording for the caller identification number, in response to an empty result from the contact database;
presenting an option to play the recording for the caller identification number; and
receiving a command to play the recording for the caller identification number.

22. The method of claim 21, wherein the recording is a portion of a previous call from the caller identification number.

23. The method of claim 21, further comprising:
in response to an empty result from the contact database, initiating recording the incoming call for a predetermined time.

24. The method of claim 21, further comprising:
receiving contact information for the caller identification number; and
deleting the recording in response to receipt of the contact information.

25. The method of claim 21, further comprising:
in response to an empty result from the contact database, accessing a usage history for the caller identification number.

26. The method of claim 25, wherein the usage history includes a text message.

27. The method of claim 21, further comprising:
replacing a ring tone of the incoming call with the recording.

28. The method of claim 21, wherein the recording is a portion of an original call from the caller identification number.

29. The method of claim 21, wherein the recording is in a video format.

30. An apparatus comprising:
at least one processor; and
at least one memory including computer program code for one or more programs,
the at least one memory and the computer program code configured to, with the at least one processor, cause the apparatus to perform at least the following,
receive an unknown caller identification number associated with an incoming call;
query a database with the unknown caller identification number for a past recording;
in response to the past recording returned from the database, generate a prompt to play the past recording; and
in response to an empty result from the database, initiate a new recording for the caller identification number.

31. The apparatus of claim 30, wherein the past recording is a portion of a previous call from the caller identification number.

32. The apparatus of claim 30, wherein the new recording is recorded for a configurable amount of time.

33. The apparatus of claim 30, wherein the computer program code is configured to, with the at least one processor, cause the apparatus to perform,
receive contact information for the caller identification number; and
delete the past recording in response to receipt of the contact information.

34. The apparatus of claim 30, wherein the computer program code is configured to, with the at least one processor, cause the apparatus to perform,
access a usage history for the caller identification number.

35. The apparatus of claim 34, wherein the usage history includes at least one text message.

36. The apparatus of claim 30, wherein the computer program code is configured to, with the at least one processor, cause the apparatus to perform,
replace a ring tone of the incoming call with the new recording.

37. A non-transitory computer readable medium including instructions that when executed by a processor, instruct the processor to:
receive an incoming call including data indicative of a caller identification number;
query a database with the caller identification number for a past recording;
in response to the past recording being returned from the database, generate a prompt to play the past recording; and
in response to an empty result from the database, initiate a new recording of the incoming call.

38. The non-transitory computer readable medium of claim 37, wherein the past recording is a portion of a previous call from the caller identification number.

39. The non-transitory computer readable medium of claim 37, including instructions that when executed by a processor, instruct the processor to:
receive contact information for the caller identification number; and
delete the past recording in response to receipt of the contact information.

40. The non-transitory computer readable medium of claim 37, including instructions that when executed by a processor, instruct the processor to:
access a usage history for the caller identification number, wherein the usage history includes at least one text message.
